(19) United States
(12) Patent Application Publication
(10) Pub. No.: US 2008/0141297 A1
(43) Pub. Date: Jun. 12, 2008

(54) METHOD OF DISPLAY ADVERTISING WITH TV VISUALIZATIONS

(75) Inventors: Thomas Dawson, Escondido, CA (US); Bob Unger, El Cajon, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: Sony Corporation, Tokyo (JP); Sony Electronics, Inc., Park Ridge, NJ (US)

(21) Appl. No.: 11/608,759

(22) Filed: Dec. 8, 2006

(51) Int. Cl. H04N 7/10; H04N 7/173

(52) U.S. Cl. 725/32; 725/131

(57) ABSTRACT

Apparatus and method for outputting advertising displays from a video device, preferably having an integral display. The video device is configured for outputting a source of regular video content when in an active mode. When switched to a stand-by mode then visualizations containing advertising are output instead of the regular content. Visualizations are preferably generated in response to stored content which can be directly displayed, displayed over generated backgrounds, or used as parameters for generating complete visualizations. The extent to which the visualizations are displayed on the video display in stand-by mode is tracked and used for determining the value of incentives to which the user is entitled. User incentives are preferably communicated over the Internet to a server which maintains point values and controls redemption for the points of various users.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains generally to televised content distribution, and more particularly to an apparatus and method of distributing sponsored visualizations from advertisers preferably in exchange for a valuable consideration or incentive.

2. Description of Related Art

It is becoming increasingly difficult for advertisers to achieve relevant exposure for their messages. Broadcast advertisers are faced with new technology, such as digital video recorder systems, which allow users to easily jump past commercials when watching stored programming, or to blank commercials in real time.

Accordingly, a need exists for new mechanisms for gaining advertising exposure. The present invention fulfills that need as well as others.

### BRIEF SUMMARY OF THE INVENTION

The apparatus and method of the present invention provides a mechanism by which the inactive state (e.g., unit being in an Off or stand-by mode) of a media device, such as a television set, is utilized by an advertiser in exchange for some valuable user consideration (e.g., monetary value, items, services, discounts, and so forth).

The apparatus provides for outputting of video media and is configured to normally output a source of video content to a display screen (e.g., internal or external). When the video device is detected entering a stand-by mode, and in response to a user preference to do so, the video apparatus generates a source of video visualizations, such as advertising material. The use of these visualizations is tracked and utilized as a basis for providing incentives to the user.

As an aid to understanding the present invention, information follows about some of the terms utilized within the specification and claims, however, it is to be appreciated that these are provided for convenience and not as a substitute for other recitations within the specification and claims.

“Stand-by mode” on a media output device is taken to generally mean that the user is not utilizing the functions of the output device in the traditional sense and the device has switched into a different operating mode. Stand-by mode can be entered manually, such as the user selecting a stand-by or Off mode, of the device. Alternatively, stand-by mode can be entered automatically in response to detecting time, events (or more precisely lack of events), and so forth. It may be that the user no longer desires to partake of the media content, however, other processes may be performed by the device, such as recording of programming, maintaining timestamps and so forth. Within the present teachings the stand-by mode is also one in which visualizations may be output, in particular visualization may present advertising content in exchange for allowing the user to garner a valuable consideration, such as points that can be redeemed for media access or other items and services, or discounts thereon.

“Visualizations” are generally meant herein to describe image or video output which contains advertising material. In one preferred implementation the visualizations are generated without accompanying audio.

One embodiment of the invention can be generally described as an apparatus for outputting video media, comprising: (a) a video display screen;

(b) means for outputting a first source of video content to the video display screen; (c) means for detecting a stand-by mode of the apparatus; (d) means for selecting a second source of video content comprising visualizations which include advertising material, in response to detecting entry into the stand-by mode; and (e) means for tracking the extent to which visualizations are displayed on the video display screen.

It should be appreciated that the first source of video content can be selected from the group of content sources consisting of television broadcast content, satellite television content, cable television content, internet video content, removable media content, fixed media content, gaming systems, graphics rendering systems and similar systems capable of generating video content. These may be similarly categorized as broadcast content, internet content, satellite content, video gaming content, content from removable media, or content from fixed media, and so forth.

The visualization generator is configured to output visualizations formed in any desired manner, such as those which have been previously stored, or those which are generated, for instance in response to stored content and visualization information. Alternatively, the visualizations can be generated fully or partially from data received in real time or near real time, such as subject to a processing delay.

The means for tracking the extent of visualization display is configured to register metrics pertinent to the advertising value of those visualizations.

By way of example, one simple metric for tracking the extent of visualization use is to register the amount of time that visualizations are displayed. In one implementation, the means for tracking the extent of visualizations can be configured to also register the time of day the visualizations are displayed, the preferences used in generating the visualizations, or a combination of time of day and preferences. An implementation preferably includes a means for communicating visualization tracking information to a remote system configured for distributing incentives to a user of the apparatus.

One implementation of the present teachings is an apparatus for outputting video media, comprising: (a) a video display screen configured for displaying video content from a first video source when in an active mode; (b) a visualization generator configured for generating a second source of video content on the video display screen in response to detecting that the apparatus is entering a stand-by mode; (c) the second source of video content comprising advertising material; and (d) a visualization monitor configured to track the extent to which the visualizations are displayed on the video display screen for determining the accrual of user incentives.

By way of example consider the user selection of visualization preferences. For instance, John-Doe Drinker may enjoy commercials about alcohol, cigarettes and gambling, but not appreciate commercials for furniture.

Another individual, Dave-Doe Delightful, may want to see ads for health related foods, supplements and exercise systems, while having no interest in seeing ads for alcohol, cigarettes and gambling. These preferences can be established by the user during configuration of the system, or in response to user input during operation, such as the user providing feedback on a given advertisement.

The apparatus is configured to allow the user to select between active and stand-by modes, for example in response to switching between On and Off modes, respectively. In another example, active and stand-by can be defined as two modes within multiple modes, such as within a media system that provides a selection between On, Off and Stand-by modes. In this example the modes could be used such that On mode provides for normal content viewing of the first video source, while Off mode prevents content or visualizations from being displayed, and with entry into stand-by mode activating the visualization generator for displaying advertising content. The selection of the Stand-by mode and/or the Off mode (e.g., on systems without a specified stand-by mode), activates the visualization generator for displaying advertising content. Mode selection can be performed manually, such as direct user input or input via a remote control, or in response to the system detecting conditions under which it should automatically enter a stand-by mode.

The visualization generator can generate outputs in response to user preference settings selected from the group of user preference settings consisting essentially of user preferences on the types of advertising, user preference on the theme of the advertising messages, and user preferences on how the visualizations are displayed on the display screen.

One implementation of the invention can be described as a method of generating on-screen advertising, comprising: (a) detecting television entry into a stand-by mode; (b) generating visualizations having advertising content that are displayed on the television in response to entry into the stand-by mode; and (c) incrementing incentive units in response to the generation of the visualizations; (d) wherein the incentive units are configured to provide a redeemable value to the consumer.

The invention provides numerous beneficial aspects for use within televisions and other video systems, a number of these aspects are outlined below.

An aspect of the invention is to provide a means for displaying advertising video on a television or other video output device which has entered a stand-by mode.

Another aspect of the invention is to monitor the extent to which advertising visualizations are displayed on the television, or other video output device, so that incentives can be distributed to the user.

Another aspect of the invention is to provide for automatic communication, to a remote server, of the information about the extent to which the visualizations are displayed, wherein incentives (e.g., points) can be added to the account of the user.

Another aspect of the invention is to provide user incentives in the form of free or reduced-fee content viewing or downloads.

Another aspect of the invention provides for activating a visualization generator in response to detecting entry of stand-by mode for the video output device.

Another aspect of the invention is the production of visualizations containing a core of advertising text and graphics which is incorporated within a visualization containing backgrounds and elements generated electronically or stored for use across multiple advertising visualizations.

Another aspect of the invention is the production of visualizations from the embedded graphics rendering system to generate a customized targeted commercial experience.

Another aspect of the invention is the generation of visualizations according to user preferences for categories (types) of advertising, theme(s) of the visualizations, and/or how the visualizations are to be displayed.

Another aspect of the invention is the generation of user selected audio to be output in combination with the generated visualizations.

A still further aspect of the invention is to provide a system for encouraging the display of visualizations by the user in response to an incentive tracking and redemption program.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a television configured for generating visualizations according to an embodiment of the present invention, and shown for communicating the extent of visualization display to a remote server device.

FIG. 2 is a flowchart of the basic process of generating visualizations and tracking their display on a video output device.

### DETAILED DESCRIPTION OF THE INVENTION

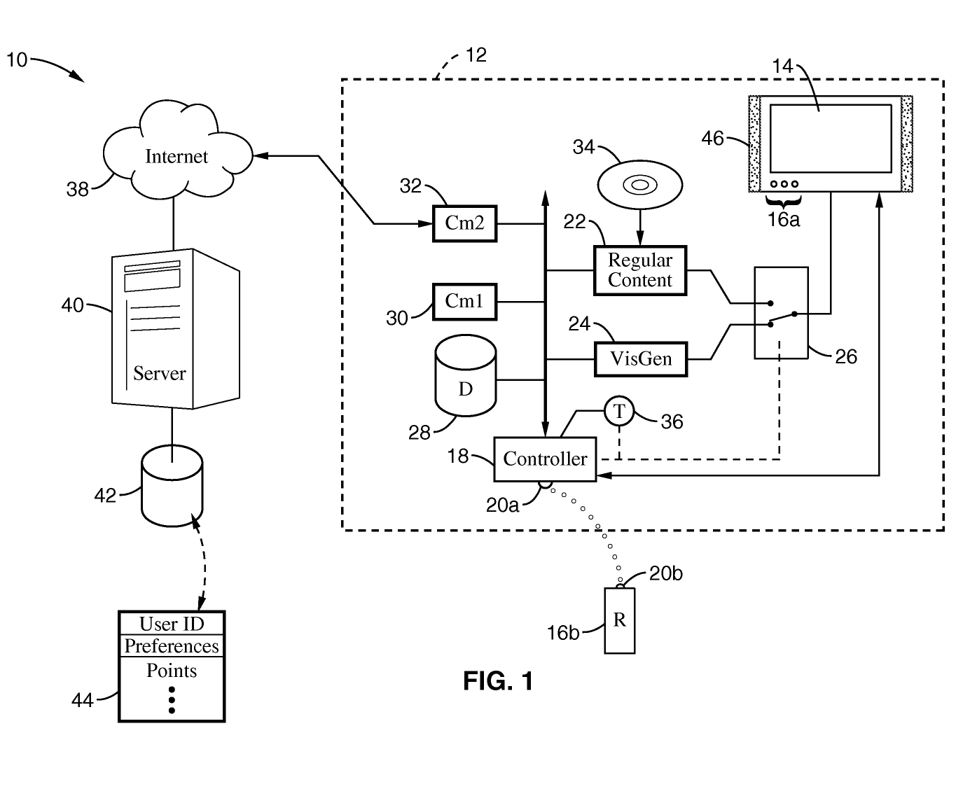

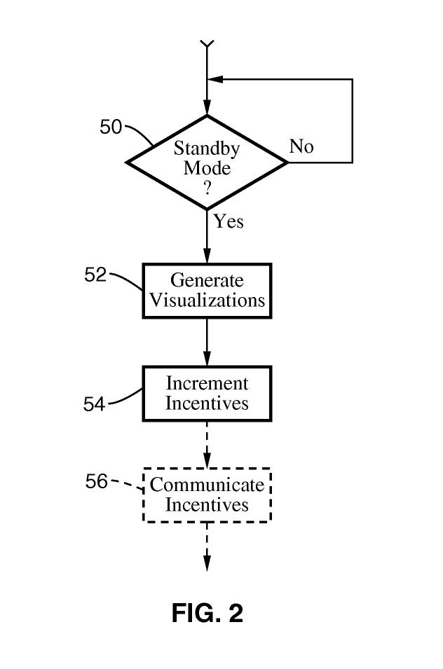

Referring more specifically to the drawings, for illustrative purposes, the present invention is embodied in the apparatus generally shown in FIG. 1 through FIG. 2. It will be appreciated that the apparatus may vary as to configuration and as to details of the parts, and that the method may vary as to the specific steps and sequence, without departing from the basic concepts as disclosed herein.

FIG. 1 illustrates an example embodiment 10 of the present invention, wherein a media device 12 comprises a television (TV) set in which advertising visuals, preferably without advertising audio, replace the Off-times of the set (e.g., Off times, stand-by modes and optionally blanked times, such as during commercials and so forth). A display 14 is shown with a plurality of manual inputs 16a while a remote control unit 16b can be optionally utilized for remotely passing commands from the user location to the television set.

A controller circuit 18 is shown within the television set and coupled to a remote control receiver 20a for receiving commands from a transmitter 20b on remote control unit 16b. It will be appreciated that circuits 20a, 20b may comprise transceivers if it is desired to pass information out to the remote control device.

A circuit 22 is shown for preparing regular content for output to display 14, and a visualization generator 24 is shown for controlling the output of visualizations to display 14. A switch 26 is shown to represent schematically switching between the regular content and visualizations. It should be appreciated that the switching is preferably performed within the programming of the apparatus, and not through the use of physical switching. Controller 18 selects whether regular programming or visualizations are to be output.

Regular output in the system preferably comprises user selected programming from outside sources (e.g., broadcast, cable, satellite, Internet, or other user devices), or from inside sources (e.g., removable media and fixed media, such as CD, DVD, Blu-Ray Disk™, disk drives and so forth), gaming systems, and the like. Examples of these content sources are represented by a data repository 28 (e.g., electronic memory and/or disk drive), a first communication port 30, a second communication port 32, and a removable media 34. The communication ports can comprise any desired electronic, optical, radio-frequency, or other communication protocols. By way of example, the ports can support broadcast, cable, satellite, internet connectivity, or connectivity (wired/wireless) with other devices. These sources can be coupled for either regular programming, as shown by removable media 34 connected to the regular content module 22, or connected so as to be accessible for both regular content output and visualization, such as shown by the ports and disk drive.

Television unit 14 is shown with audio transducers 46 (e.g., speakers) for the output of audio associated with regular content, or with audio associated with specific implementations or modes of the visualizations generated according to the present invention, such as music or other audio not carrying an advertising message. Controller 18 can selectively output audio content through the speakers, or optionally generate audio output to accompany the visualizations, such as user selected music or Internet radio stations.

In considering stand-by modes, it should be appreciated that in many TV sets the display is blanked while in stand-by mode, although the internal circuitry remains active so that content can be received, such as for storage.

It should be noted that we will refer to “stand-by mode” in relation to the operation of the visualizations even though the user may have selected “Off”, or other stand-by mode designations, or the apparatus may enter stand-by mode in response to a set of conditions being met (or not being met), such as a timeout.

Visualization generator 24 can be implemented in a number of alternative ways without departing from the teachings of the present invention, the following being provided by way of example. In one implementation, or operating mode, the entire visualization is stored, such as within media device 12, and output when the media device enters a stand-by mode (e.g., stand-by mode, Off mode, or other inactive modes). This form of visualization content comprises advertising material in the form of text, rendered graphics, images, videos, raster data, and polygon data, either separately or in any desired combination. The visualizations are preferably not accompanied by a stream of audio associated with the visualizations (advertising audio). In one implementation, the circuitry or software for generating on-screen (OSD) menus and graphics is utilized to render the visualizations. This capability may be enhanced or augmented in a given video device generating visualizations according to the invention. In this case the downloaded visualization data makes use of the rendering mechanisms to generate a customized targeted commercial experience, depending on the processing power available in the rendering engine. In one aspect of the invention, the visualization distribution mechanism polls the video device and ascertains the type and power of available rendering, wherein the commercial data downloaded is customized to assure suitability with the video device so that the extent and complexity do not overwhelm the video device.

In another implementation, the visualizations are built upon the advertising text, images and/or video. For example, foreground image/video are displayed (e.g., stationary, or moving on the display) with backgrounds being generated according to user preferences. Additionally, the text and graphics within the visualizations can be generated in response to user preferences. It should be appreciated that the graphics rendering portions of the video device can be utilized wholly or in part for creating some or all of the visualizations according to the present invention.

In another implementation, the entire visualization (e.g., both foreground and background) can be generated from stored data, such as using sprite techniques from the video gaming industry. It should also be appreciated that visualizations can be generated according to any combination of the above techniques. Data for use in generating visualizations can be received in any desired manner, such as from server 40 over the Internet into port 32 to controller 18 which stores the information within disk drive 28. Less preferably, all or a portion of the visualization data can be received in real time, or real time subject to a processing delay.

In one embodiment the visualization generator is implemented as programming executing on a computer processor, or processors, within the media device. The programming is configured to selectively output regular content when the media device is in an active mode, or to output visualizations when the media device is in a stand-by mode. It should be appreciated in this case that switching between outputting regular content (e.g., from content sources 28, 30, 32 and/or 34) and outputting visualizations can be performed by media device programming executed in response to media device mode, wherein physical switching of signals external to the processor would not be necessary.

In one preferred implementation the visualizations are not accompanied by an audio track or audio advertising. The lack of advertising audio output encourages the user to participate in the visualization incentive program, as they can perform other functions near the television, including conversations (direct or telephonic), without being disrupted by advertising audio.

In another implementation, the apparatus is configured to allow the user to select audio for accompanying the visualizations. An example of this audio-augmented implementation would allow the user to select a category of audio/music to accompany the visualizations, this content being streamed or downloaded to the television. Alternatively, visualization output can be combined with internet radio functions, wherein the visualizations containing advertising are displayed in combination with the audio content from the internet radio station. As a further alternative, audio can be played as received from a content source, such as from a removable media 34, or from disk drive 28 (or other storage device), or received from one of the communication ports.

In another implementation, music with at most a subtle tie-in with the visualization is provided. Examples of these include, themed music, music to set the mood of the visualization, nature sounds, sound effects and so forth from the advertiser are played, preferably in response to user selection of this mode of advertiser audio. For example, in the case of a visualization of a soft drink advertisement the accompanying audio is a piece of actual music (i.e., not a jingle) which provides an enjoyable listening experience, yet contains a musical theme or elements that tie in with the advertising campaign, thus aiding to anchor the branding concept. The themed music can be generated in a number of musical styles (e.g., classical, pop, hard-rock, country and so forth), wherein user preferences determine which is to be played. In the absence of these audio elements for a particular visualization, the system can select stored background music (e.g., MP3), retrieve music content (e.g., broadcast or internet content), or mute any audio output.

It should be appreciated that audio can also be generated in response to the above audio modes utilized either separately or in any desired combination without departing from the teachings of the present invention.

Modes of the apparatus can allow for selection of interaction between the visualizations and audio. For example, characteristics of the backgrounds and foregrounds of the visualizations can be modulated in response to characteristics of the audio, such as channel, tone, amplitude and so forth.

Examples of visualization characteristics which are to be modulated include movement, color, and/or intensity. These optional audio-enhanced visualizations can provide the user with the ability to enjoy audio material while the visualization is being displayed, and to further enhance the appeal of visualizations by modulating them in response to characteristics of the audio source.

The conditions under which the visualizations are generated should be considered. In a preferred embodiment, the user agrees to display these visualizations in exchange for a consideration (e.g., media access, item, service, discount, or combination thereof), either as full payment or partial payment. The agreement with the user can take any desired form, for example, as a confirmation of an associated application program being installed, detection that the visualizations are being displayed, or other means for determining compliance with the display of visualizations. In one implementation, the time and/or periods are tracked in which visualizations are displayed.

A means for tracking 36 the extent of visualizations is shown which registers metrics about the output of visualizations, for example the elapsed time. It should be appreciated that many types of information can be registered by the tracking means, depending on the specific implementation, such as time of day, types of advertising, visualization preferences, and so forth in order to assure that the display of this form of advertising is properly valued by the system so that a corresponding level of incentives may be distributed.

Information about the extent to which visualizations are displayed are communicated to a system for processing user incentives. By way of example and not limitation, communication port 32 of media device 12 is shown configured for communicating over Internet 38, with an incentive processing system, such as comprising a server 40 and data storage media 42. A repository of user-incentive information, preferably a hierarchical database, is stored on media 42 configured with user records 44 containing user information, preferences, and the level (or levels) of accrued incentives, such as in the form of “points”. It will be recognized that user preferences can be maintained for server 40, such as describing the types of incentives for which incentive points are to be accrued, how the user wants to view or control account parameters, how the user wants to log incentives accruing from multiple media devices of the user, and so forth.

According to one implementation, user incentives are received as points with a point redemption system, in response to displaying the visualizations. For example, points are accrued based on the extent to which visualizations are displayed. The accrued points (or other measure of visualization value used) can be redeemed by the user in exchange for viewing or obtaining content which is traditionally accessed for a fee. Content access can be in the form of streaming access, or downloads, while the points may be exchanged as either full or partial payment (reduced fee). Points may be surrendered in other ways, such as for obtaining discount certificates on content. In addition, points can be exchanged for any other goods and services provided under the terms of the point redemption program.

Returning now to the implementation of media device 12, the programming is preferably configured to allow the user to set visualization preferences. One example set of categories may include visualization preferences such as colors/patterns, music, gender, age and life style. It will be appreciated that the same commercial data sent to different video systems can thus generate different commercial visualizations depending on user selected preferences. Other examples of these preferences include selecting the material of interest, for example user selection of categories, sub-categories and/or types of products of interest (e.g., new products, automobiles, computers, entertainment systems, personal electronics, food products, household products, services, and so forth). It is preferable that the user can select (or enter) multiple advertising categories and sub-categories from which the visualizations are derived. Optionally, the system can allow the preferences to be set according to day of time, such as the day of the week and/or the time of day. In this mode the user can select preferences which are modified based on day or time, for example showing advertising that relates to food items at one point in time, and tools at another time. The advertisers themselves may also establish their own day and/or time criterion, for example changing the type of food items advertised in response to the time of day.

In another variation the system provides the user with options as to how to display the visualizations, examples include themes such as sports, science fiction, romance, action, food, cartoons and nostalgia. Alternatively, or additionally, the system allows the user to set preferences for the properties of the visualizations, for example characteristics such as screen-on-screen, motion, colors, color palettes, and so forth. In an advanced option the system can be configured to receive user qualification information, such as in response to selecting specific advertising categories (e.g., million-dollar homes or expensive sports cars).

FIG. 2 illustrates an example embodiment of the method for encouraging the display of advertising visualizations in response to user incentives. As programming is executing on a computer controlling the television set, or other media device, a change to stand-by mode is detected at block 50. Upon entering stand-by mode the generation of visualizations commences as per block 52, such as in response to received advertising content and any user preferences which have been set. As the visualizations are being displayed, incentives for the user are incremented at block 54.

Although shown as a single event, it will be appreciated that the incentives are accrued periodically or otherwise in response to the extent, and optionally value, of the visualizations being displayed. The accrual of incentives is preferably communicated, as shown by optional block 56, to an external system such as server 40 shown in FIG. 1.

A preferred implementation of the present teachings arise as a cooperative effort between the manufacturer of the media output device, such as a television set manufacturer, and a content provider (e.g., IP TV, IP Radio, cable, or satellite content provider, and other organization dealing with content and/or advertising). The manufacturer produces media devices capable of displaying the visualizations and tracking the extent that the visualizations are displayed. The content provider is correspondingly responsible for generating the visualization or data from which the visualizations are generated, establishing an application for tracking “screen time” of the visualizations, accumulation of user points, and redemption of user points. It should be appreciated, however, that various alternative business relationships can be utilized for producing the media device and the applications for disseminating the visualizations and controlling associated distribution of incentives. Furthermore, any of the responsibilities described above can be performed by either party or third party processors.

The system and method of the present invention can be implemented within various media devices, and is particularly well-suited for use in television sets, video players, computers, and so forth. It will be appreciated that a form of the system can be less preferably implemented on an audio system, wherein instead of the “display of visualization”, the system would provide “background audio” containing preferably subtle audio advertising content when the system is otherwise in stand-by mode. It will be appreciated that these audio segments may be related to the subtle tie-in music described earlier.

It should be appreciated that if the present system and method is implemented within an electronic system without an integral output device (e.g., video) that a means is preferably provided for accurately detecting that the visualizations are being output so as to have an impact on the user. By way of example, visualization output can be detected directly using optical detectors, or indirectly by communicating with the video output device being used (e.g., television set, video monitor, and so forth), or similar. The ability to detect visualization output assures that the visualizations are actually being displayed, so that the user does not accrue point value when the visualizations are not being displayed, such as in response to a video output device being turned Off, or other situations in which the video signal of the visualizations is not being displayed.

The system can be implemented separately or in combination with other forms of on-screen advertising. For example, the visualizations can be less preferably generated in response to user input or the detection of other conditions under which visualizations are to be generated.

Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for outputting video media, comprising:
means for outputting a source of regular video content to a video display screen;
means for detecting a stand-by mode of said apparatus;
means for generating a source of video content visualizations, including advertising material, in response to detecting entry into said stand-by mode; and
means for tracking the extent to which visualizations are to be displayed on the video display screen.

2. An apparatus as recited in claim 1, wherein said regular video content is selected from the group of content sources consisting of television broadcast content, satellite television content, cable television content, internet video content, removable media content, fixed media content, and gaming systems.

3. An apparatus as recited in claim 1, wherein said visualization generator is configured to output visualizations which have been previously stored, or to generate visualizations in response to stored content and visualization information.

4. An apparatus as recited in claim 1, wherein said means for tracking the extent of visualization display is configured to register the amount of time that visualizations are displayed.

5. An apparatus as recited in claim 4, wherein said means for tracking the extent of visualizations is configured to register the times at which the visualizations are displayed, the preferences used in generating the visualizations, or a combination of the display times and the preferences.

6. An apparatus as recited in claim 1, further comprising means for communicating visualization tracking information to a remote system configured for distributing incentives to a user of said apparatus.

7. An apparatus for outputting video media, comprising:
a video display screen configured for displaying video content from a first video source when in an active mode;
a visualization generator configured for generating a second source of video content on said video display screen in response to detecting that said apparatus is entering a stand-by mode;
said second source of video content comprising advertising material; and
a visualization monitor configured to track the extent to which said visualizations are displayed on said video display screen for determining the accrual of user incentives.

8. An apparatus as recited in claim 7, wherein said first source of video content can be selected from broadcast content, internet content, satellite content, video gaming content, content from removable media, or content from fixed media.

9. An apparatus as recited in claim 7:
wherein said apparatus allows the user to select from On, Off and Stand-by modes;
wherein the selection of said On mode provides for normal content viewing of said first video source;
wherein the selection of Off mode prevents content or visualizations from being displayed; and
wherein the selection of Stand-by mode activates the visualization generator for displaying advertising content.

10. An apparatus as recited in claim 7:
wherein said apparatus allows the user to select from On and Stand-by modes; and
wherein selection of said Stand-by mode activates the visualization generator for displaying advertising content.

11. An apparatus as recited in claim 7, wherein said visualization generator is configured to output visualizations which have been previously stored, or to generate visualizations in response to stored content and visualization information.

12. An apparatus as recited in claim 7, wherein said visualization generator outputs the visualizations in response to user preference settings selected from the group of user preference settings consisting essentially of user preference on the types of advertising, user preference on the theme of the advertising messages, and user preference on how the visualizations are displayed on the display screen.

13. An apparatus as recited in claim 7:
wherein said detecting that said apparatus is entering a stand-by mode comprises programming executable on said apparatus for,
registering manual and remote control user inputs, and
checking said user input to determine if the user has selected stand-by mode.

14. An apparatus as recited in claim 7, further comprising a communication module configured for communicating information from said visualization monitor to an external system which controls the generation of user incentives.

15. A method of generating on-screen advertising, comprising:
detecting television entry into a stand-by mode;
generating visualizations, containing advertising, on said television in response to entry into said stand-by mode; and
incrementing incentive units in response to the generation of said visualizations, said incentive units having a redeemable value to the consumer.

16. A method as recited in claim 15, wherein said visualizations are generated in response to user preference settings.

17. A method as recited in claim 15, wherein said visualizations are generated in response to user preference settings selected from the group of preference settings consisting essentially of user preference on the types of advertising, user preference on the theme of the advertising messages, and user preference on how the visualizations are displayed on the television.

18. A method as recited in claim 15, further comprising communicating information on incentive units to an external system which controls the generation of user incentives.

19. A method as recited in claim 15, wherein said visualizations have been previously stored, or have been generated in response to stored advertising content.

20. A method as recited in claim 15, wherein said incrementing of incentive units is performed in response to the amount of time that visualizations are displayed.
